(19) United States
(12) Patent Application Publication
(10) Pub. No.: US 2006/0117324 A1
(43) Pub. Date: Jun. 1, 2006

(54) System and method for controlling a robot

(75) Inventors: Yasser Alsafadi, Yorktown Heights, NY (US); Octav Chipara, Bloomington, NY (US); Amrq Yassin, Chesterfield, MO (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,902

(22) PCT Filed: Dec. 4, 2003
(86) PCT No.: PCT/IB03/05646

§ 371 Date: Jun. 16, 2005

(30) Foreign Application Priority Data
Dec. 19, 2002 (US) 60434549

(51) Int. Cl. G06F 9/44; G06F 9/46

(52) U.S. Cl. 719/320

(57) ABSTRACT

The present invention is directed to a computer-implemented system and method for controlling robots (41) using a high-level programming language. The invention defines three programming languages, i.e., two high-level languages and a low-level language. A first high-level programming language is referred to herein as a robot scenario language (RSL) (20), in which an end-user (18) creates a robotic presentation (40) in terms of high-level behaviors or actions. A second high-level language, referred to herein as a robot behavior language (RBL) comprised of templates for describing how each high level behavior or action in the high-level (RSL) language is to be transformed or mapped into low-level language commands for directly controlling the hardware of the robot (41). The low-level language referred to herein as a robot hardware language (RHWL).

### 1. FIELD OF THE INVENTION

The invention relates to a computer-implemented method for controlling a robot More particularly, the present invention is related to a method for controlling a robot by transparently transforming a high-level programming language into low-level language hardware commands directly executable by the robot

### 2. DESCRIPTION OF RELATED ART

While it is well accepted that robots have been and are being developed for a wide range of activities, little to no research has been performed to date on robots tasked for activities that do not require complex interaction with their environment. In the prior art, initiatives in defining robot languages have been divided into two trends: developers either define the actions and responses of the robots at a low-level (i.e., what actions the hardware needs to perform or what sensor stimuli need to be handled); or they define complex high-level languages that are used for task description (e.g., Task Description Language) aimed at solving highly complex tasks in which actions need to be synchronized. Both approaches do not satisfy the needs of users intending to use robots for simple activities that do not require complex interaction with the environment. Such activities may include, for example, the robot as salesman, cooking robots, and cleaning robots. For these activities it would be desirable for a user having no particular programming skills, such as an artist or an advertising executive, to be able to manipulate the robot for a sales presentation or a cooking demonstration using only high-level language statements. Accordingly, some means is required for translating the high-level language commands into low-level language commands which are directly executable by the robot. The present invention is directed to satisfying these and other objectives.

The present invention is directed to a computer-implemented system and method for controlling robots using a high-level programming language. The invention defines three programming languages, i.e., two high-level languages and a low-level language. A first high-level programming language is referred to herein as a robot scenario language (RSL), in which an end-user creates a robotic presentation in terms of high-level behaviors or actions. A second high-level language, referred to herein as a robot behavior language (RBL) comprised of templates for describing how each high level behavior or action in the high-level (RSL) language is to be transformed or mapped into low-level language commands for directly controlling the hardware of the robot The low-level language referred to herein as a robot hardware language (RHWL).

In accordance with one aspect of the invention, a method for controlling robots using the high-level programming language includes the steps of: supplying a first set of programming statements defining behaviors to be performed by said robot as a first input to a transformation engine; supplying a second set of programming statements comprised of behavioral templates defining rules for interpreting said behaviors as a second input to said transformation engine; and transforming, in the transformation engine, said behaviors in accordance with said defined rules to yield a third set of robotic commands for directly controlling said robot

In accordance with another aspect of the invention, a system for controlling robots using the high-level programming language, the system including: means for supplying a first set of programming statements defining behaviors to be performed by said robot as a first input to a transformation engine; means for supplying a second set of programming statements comprised of behavioral templates defining rules for interpreting said behaviors as a second input to said transformation engine; and means for transforming, in the transformation engine, said behaviors in accordance with said defined rules to yield a third set of robotic commands for directly controlling said robot.

One advantage afforded by the invention is that a user having no particular expertise in programming is provided a capability for constructing a robotic presentation by simply utilizing the high-level RSL programming language without concern for mastering arcane high-level task description language statements or low-level programming language statements.

Another advantage of the invention is the ease with which a robot may be adapted or upgraded. Consider the situation where a robot is malfunctioning due to a defective component. The replacement component may not follow the same specifications as the original component. Normally, this would require re-writing low-level code in the native language of the robot to accommodate the difference in the specification of the new component which is both time-consuming and subject to error. The present invention overcomes this drawback by simply changing the mapping between the high-level (RSL) programming language and the low-level (RHWL) language by simply changing the mapping via the RBL template language. By simply modifying the RBL templates to conform with the different specification of the new component, a user is relieved of the task of having to re-write low-level code. The RBL language providing, in one sense, a layer of abstraction.

Another advantage afforded by the present invention is the ability to achieve a uniform behavioral result across a wide variety of robotic platforms having different hardware configurations. As one example, consider a high-level language behavior instructing a robot to “move 10 feet from its current position”. This uniform behavioral result is achievable for any robot irrespective of its internal hardware configuration. This capability is provided by virtue of the separation between the low and high level languages.

The invention is well suited to applications in which robots are used to perform non-complex tasks that do not require complex interaction with the environment. Such applications may include, for example, a robot as salesman, cook, cleaner or for use in a manufacturing process using CNC machines. However, the invention is not inherently limited to a particular class of applications.

The foregoing features of the present invention will become more readily apparent and may be understood by referring to the following detailed description of an illustrative embodiment of the present invention, taken in conjunction with the accompanying drawings, where:

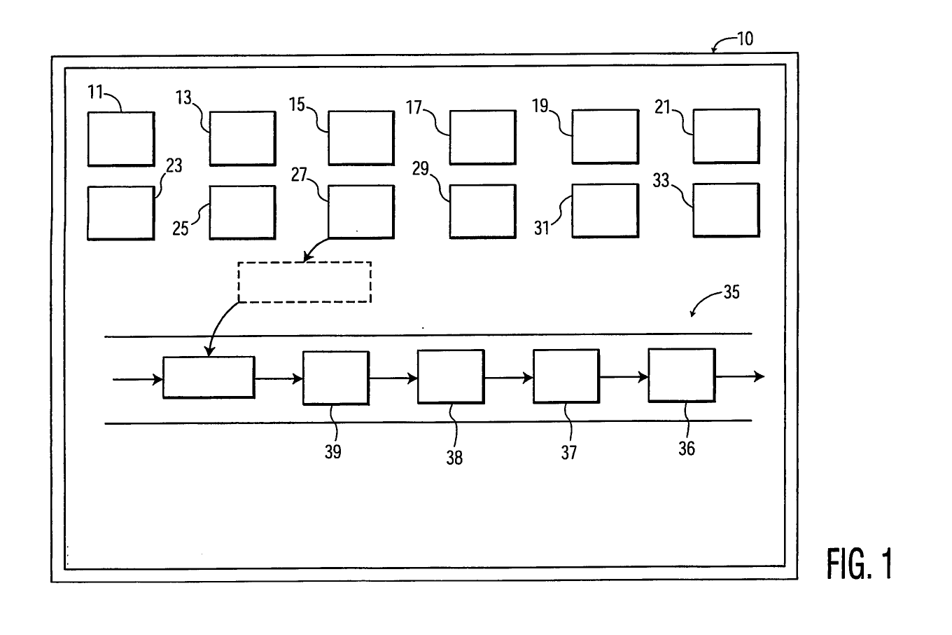

FIG. 1 illustrates a snapshot image of a computer terminal display screen for creating a high-level robotic presentation in the RSL language;

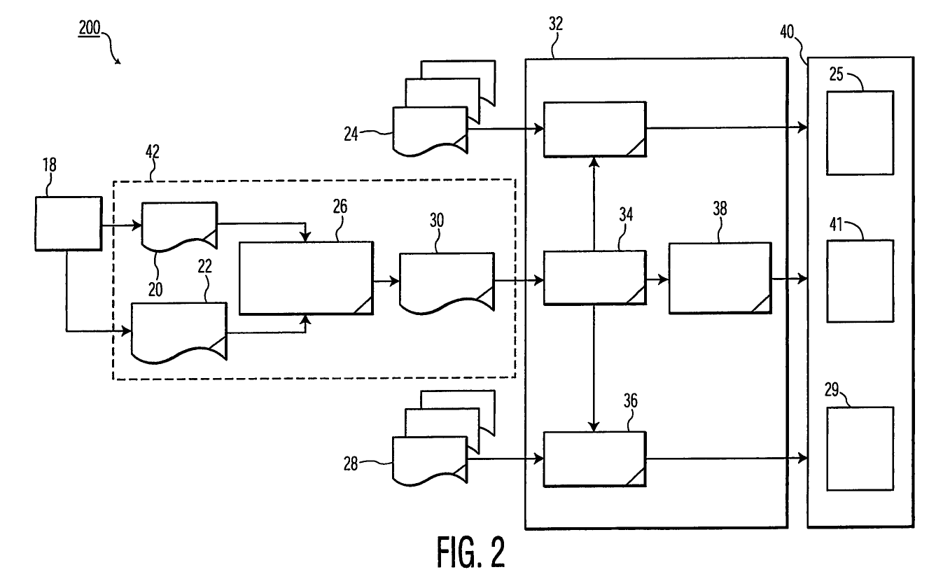

FIG. 2 is a block diagram illustrating the process flow for transforming the high-level RSL instructions, and associated RBL behavioral templates, into low-level RHWL instructions for directly controlling the robot's hardware; and

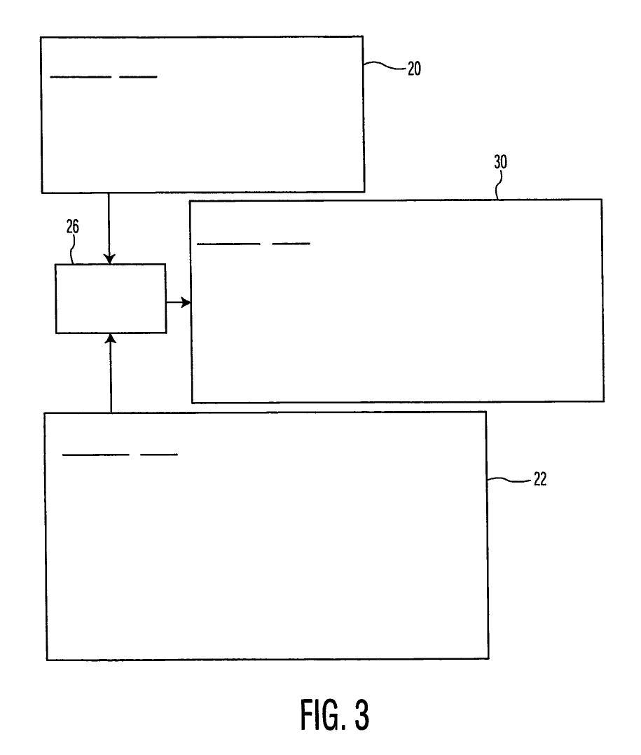

FIG. 3 is a more detailed illustration of process block 42 of FIG. 2 for the illustrative example.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

The present invention, in its broadest application, makes use of three programming languages, a first language which may be generally characterized as a high-level programming language, a second language which may be generally characterized as a high-level template language and a third programming language generally characterized as a low-level programming language. The three programming languages form a basis or structure for controlling robotic movement via the high-level programming language.

The principles of the present invention will be described herein in the context of extensible markup language (XML). XML is a preferred implementation given the vast amount of existing infrastructure. It is to be appreciated, however, that the XML embodiment is a non-limiting exemplary embodiment.

As stated above, the present invention defines three programming languages and a method of their use. Each will be defined as follows.

A. The Robotic Scenario Language (RSL)

The RSL language is a high-level programming language constructed for ease of use by a non-sophisticated end-user having no particular programming skills. For example, it was developed for use by creative/artistic people little familiarity or interest with programming languages, but desiring to create robotic presentations for any number of purposes including making sales demonstrations to be conducted, for example, in malls or parks or in the lobby of movie theaters.

One notable attribute of the high-level RSL programming language is that, by virtue of being a high-level language, the language statements are written without consideration or concern for the attributes or capabilities of a specific robot. The high-level language commands describe robotic behaviors without specifying how the behaviors are implemented. As an example, the RSL language statements typically define familiar behaviors to be performed by a robot such as, ‘run’, ‘smile’, ‘blink’, ‘dance’ and so on. The statements could further include variations of standard behaviors, such as, for example, defining the various types of dances such as country dances, rock-and-roll dances, slow dances or types of laughter such as ‘belly laugh’ or ‘chuckle’ and so on.

FIG. 1 illustrates an embodiment of how the RSL language may be utilized by an end-user, sitting at a computer terminal, desiring to create a robotic web presentation. FIG. 1 illustrates a snapshot image of a computer terminal display screen 10 running a program for creating a robotic presentation. As shown, A palette of selectable icons 20 for defining desired robotic actions are defined in an upper portion of the display screen 10 including a “run” icon 11, “jump” 13, “smile” 15, and so on. The user would create a robotic presentation by simply grabbing and dropping the selectable icons in a desired presentation sequence 35. The snapshot image of FIG. 1 illustrates that the end-user has created a partial robotic web presentation consisting of four icons commanding the robot to first “jump” 36, “smile” 37, sigh” 38 and “roll eyes” 39 in that order as indicated by the time axis. Using the simplified icon driven approach, a robotic presentation may be created in a straight forward easily understood manner.

In accordance with the embodiment, the esoteric aspects of robotic movement are completely transparent on the applications level. Once completed, the RSL based high-level presentation may be stored for later use and/or modification. It is also contemplated that the RSL file, once created, may be transmitted electronically to one or more remote locations for directing the activities of particular robots.

B. The RBL Template Language

The RBL language is comprised of behavioral templates for defining how the RSL high-level language commands may be implemented. That is, the RBL behavioral templates describe how each high level behavior or action in the high-level (RSL) language is transformed or mapped into low-level language commands for directly controlling the hardware of the robot. The RBL behavioral templates are made up of one or more rules. For example, one RBL behavioral template for mapping an RSL command for ‘smiling’ could include a first rule for instructing the robot to move the outer portions of his mouth upward and a second rule instructing the robot to display all of his teeth.

The RBL templates exist in a many-to-one relationship with the RSL commands. In other words, each RSL commands may have any number of RBL templates specifying a different set of rules for performing the same behavior. Referring to the previous example, a second RBL behavioral template for ‘smiling’ might include a rule for instructing the robot to move its cheeks up and down rapidly. As is apparent, there is no restriction on the number or variety of different RBL templates which may be created for a particular RSL command.

The RBL behavioral templates could conceivably be created and maintained by an entity separate and distinct from the persons creating the robotic scenario given that some degree of programming expertise is involved with their creation and maintenance.

C. The RHWL Language

The third programming language of the invention is a low-level robotic hardware language (RHWL) for directly controlling the hardware of the robot. This is essentially the native language of the robot. The RHWL language represents the totality of low-level instructions that the robot can execute.

D. One Embodiment

To illustrate the operation of the present invention according to one embodiment, an example is provided in which two of the three programming languages (i.e., RSL and RHWL) are described as XML language embodiments and the third programming language is described as an extensible stylesheet language (XSL) language embodiment. XML is a preferred implementation given the extensive infrastructure currently being made available.

Referring now to FIG. 2, there is shown a process flow diagram 200 describing a computer-implemented system and method for remotely controlling the actions of a robot (referred to as Stan) via a high-level programming language.

In the illustrative example, an end-user desires to construct a robotic presentation involving a single action, namely, taking a picture. The example is purposefully simplistic so as not to obscure the principles of the invention.

In the illustrative example, it is assumed that the robot (Stan) has a picture taking capability (i.e., a video camera for a head) and is required to take the picture of a by-stander in accordance with an envisioned robotic sales presentation.

First, an end-user 18, for whom it is assumed has no familiarity or interest with programming languages, is tasked with creating a robotic sales presentation. The user may create the robotic sales presentation with the assistance of the icon driven program described above with reference to FIG. 1 to yield as an end product, an RSL file 20 consisting of a sequence of actions (behaviors) written in the first high-level programming language. The sequence of actions or behaviors collectively defining the robotic presentation. In the instant example, the robotic sales presentation comprises a single action, that of taking a picture by the robot 41. It is to be appreciated, however, that in a more realistic example, the scenario could include hundreds of actions to be performed by the robot 41.

In the instant example, the user may utilize the icon driven program to create the robotic presentation for taking a picture by simply selecting the “Take a picture” icon 17 from the palette of selectable icons for inclusion in the presentation stream 35. The user 18 may save the presentation stream as an RSL file 20 named, e.g., “my_presentation.rsl”. In an XML embodiment, the RSL file 20 defining the robotic sales presentation for ‘taking a picture’ may include the following code sequence.

TABLE I

| Code line | Code |
|---|---|
| 1 | <RSL> |
| 2 | <stan xmins=“www.philips.com/Robots/STAN> |
| 3 | <stan:play>Take_Picture</stan:play> |
| 4 | <stan> |
| 5 | </RSL> |

The coding statements (1-5) are written in the RSL programming language utilizing an XML embodiment. The general construction of the coding statements (1-5) are known in the art of programming and will not be further described. However, of interest is the fact that coding statement 3 defines a high-level language RSL programming language command for a high-level ‘behavior’ associated with taking a picture, i.e., “Take_Picture”. The coding statement, however, provides no details or specificity concerning how the ‘behavior’ for taking a picture is to be carried out or implemented by the robot.

What has been described to this point is the creation of a high level robotic sales presentation written in the high-level RSL programming language.

As described above, the robot 41 cannot natively process high-level language RSL commands. The robot 41 is only capable of being manipulated or controlled via the low-level robot hardware language (RHWL) commands. Therefore, the present invention provides a mechanism to translate or map the high-level RSL commands into the low-level robot hardware language commands which can be natively processed by the robot The RBL behavioral templates, written in a second high-level language provide such a mapping. That is, the RBL behavioral templates include rules for defining how to interpret the high-level language RSL commands.

In the instant example, a single RBL behavioral template was created in the second high-level programming language for interpreting the RSL command, “Take a Picture” as follows:

TABLE II

| Code Line | Code |
|---|---|
| 1 | <RBL> |
| 2 | <xsl:template match=“stan:play”> |
| 3 | <xsl:if test=“parent::node( )[stan:play=‘take picturet’]”> |
| 4 | <xsl: element name=“cam:tilt”> 40 < /xsl:element> |
| 5 | <xsl: element name=“cam:pan”> 20 < /xsl:element> |
| 6 | <xsl: element name=“cam:take picture”> < /xsl:element> |
| 7 | <xsl:if> |
| 8 | </xsl:template> |
| 9 | </RBL> |

The coding statements (1-9) are written in the RBL programming language utilizing an XSL language embodiment The general construction of the coding statements (1-9) are known in the art of programming. The statements of interest from Table II include statements 3 and 4-6. First, coding statement 3 defines a matching behavioral template for the ‘take picture’ behavior. In accordance with the principles of the invention, during the process of transformation, each behavior in the RSL file 20 must be matched with a matching behavioral template in the RBL file. The RBL file is made up of a large number of templates defining a mapping for all of the contemplated behaviors written in the RSL language.

In the instant example, the RSL file 20 is parsed by the transformation engine 26 to select each behavior included therein. For each RSL behavior, the RBL template file 22 is searched to locate a behavioral template which matches the RSL behavior. Once the matching behavioral template is found, the rules associated with the matching template are used in the transformation engine 26 to partially construct the RHWL file 30, which consists of low-level hardware commands for directly controlling the robot to, for example, “take a picture.” Referring again to Table II,, the RBL behavioral template for taking a picture include three rules as specified on lines 4-6 which interpret the “Take_picture” behavior in one way as three operations: (1) tilting the camera 40 degrees, (2) panning the camera 20 degrees and (3) taking the picture.

In general, the XSL Transformation engine 26 has two inputs, a first input for receiving the high-level language RSL file 20 and a second input for receiving the RBL templates file 22. The XSL Transformation engine 26 is the mechanism for performing the translating (mapping) of the RSL behaviors in accordance with the RBL behavioral templates into a single set of low-level robotic hardware commands (RHWL file 30) in the native language of the robot for directly controlling the actions of the robot In the instant example, the RHWL file 30 which results from the process described above is as follows:

TABLE III

| Code Line | Code |
|---|---|
| 1 | <RHWL> |
| 2 | <camera xmins=“www.philips.com/robot/camera/specific |
| | Camera” |

| | |
|---|---|
| 3 | <tilt> 40 <tilt> |
| 4 | <pan> 20 <pan> |
| 5 | <takepicture> |

| | |
|---|---|
| 6 | </camera> |
| 7 | </RHWL> |

The coding statements (1-7) are supplied to the robot hardware handler 35 unit of the robot controller via the distributing unit 34 and are written in the RHWL programming language utilizing an XML embodiment. The construction of the coding statements are known in the art of programming. Of note are statements 3 and 4 which define low-level robotic hardware language statements for directly controlling the actions of a robot. Specifically, RHWL statements (3) and (4) direct the robot 41 to tilt its head 40 degrees and then pan its head by 20 degrees.

Also shown in FIG. 2 are video 24 and audio 28 files that may be included in the robotic presentation as an audio 25 and video stream 29 to be downloaded as supplementary files to the robot controller 41 for providing video and audio enhancements to the robotic presentation 40.

FIG. 3 is a more detailed illustration of process block 42 of FIG. 2 for the illustrative example. It is noted that for the XML embodiment of the invention, the process flow is analogous to the technique for processing XML source documents and XSL stylesheets using an XSLT transformation engine. As is well known by those familiar with the art, an XSLT transformation engine is used for transforming XML documents into other types of documents. In particular, XSLT offers capabilities for transforming raw XML data into another type of document, such as a well-formed HTML document An XSLT transformation engine operates by taking an XML document as an input source and applying an XSL style sheet to it to generate a transformed output (e.g., a well-formed HTML document), as a final product. The XSL style sheet contains templates, each of which dictates rules and is specified with a matching pattern. When the XSLT transformation engine finds source XML data that matches a template pattern in the XSL style sheet, it applies that template's styling rules to the data—extracting XML data, filtering out unwanted sections, and manipulating data into some presentable layout. In an analogous manner, the RSL file 20, as shown in FIG. 3 is a type of XML document The RBL file 22 of FIG. 3 is analogous to an XSL stylesheet In accordance with the principles of the invention, when the XLST transformation engine finds source XML data (an RSL command) that matches a template pattern (an RBL template), it applies the template's styling rules (the behavior specified by the RBL template) to the XML data (the RSL command) and generates therefrom the RHWL commands, i.e., RHWL file 30.

Having thus described an embodiment of a computer-implemented system and method for controlling robots using a high-level programming language, it should be apparent to those skilled in the art that certain advantages of the system and method of the invention have been achieved. The foregoing is to be constructed as only being an illustrative embodiment of this invention. Persons skilled in the art can easily conceive of alternative arrangements providing a functionality similar to this embodiment without any deviation from the fundamental principles or the scope of this invention.

1. A computer-implemented method for controlling a robot (41), the method comprising the steps of:
(a) supplying a first set of programming statements (20) defining behaviors to be performed by said robot (41) as a first input to a transformation engine (26);
(b) supplying a second set of programming statements (22) organized as a plurality of behavioral templates defining rules for interpreting said behaviors as a second input to said transformation engine (26); and
(c) transforming, in said transformation engine (26), said behaviors in accordance with said defined rules to yield a third set of robotic programming statements (30) for directly controlling said robot (41).

2. The method of claim 1, wherein said first set of programming statements
(20) are written in a first high-level programming language.

3. The method of claim 1, wherein said second set of programming statements (20) are written in a second high-level programming language.

4. The method of claim 2, wherein said first set of programming statements are in the form of an extensible markup language (XML) and the second set of programming statements are in the form of an extensible stylesheet language (XSL).

5. The method of claim 3, wherein said first set of programming statements are in the form of an extensible markup language (XML) and the second set of programming statements are in the form of an extensible stylesheet language (XSL).

6. The method of claim 1, wherein one of said defined behaviors from said first set of programming statements (20) is associated with one or more of said plurality of behavioral templates from said second set of programming statements (22).

7. The method of claim 1, wherein said third set of robotic programming statements (30) are written in a low-level robotic hardware language directly executable by said robot (41).

8. The method of claim 1, wherein said transforming step (c) further comprises the steps of:
(1) sequentially selecting said behaviors from said first set of robotic programming statements (20);
(2) for each behavior selected at said step (1), searching said plurality of behavioral templates (22) to locate a behavioral template matching said selected behavior; and
(3) applying said matching behavioral template at said step (2) to said selected behavior at said step (1) to yield at least a portion of said third set of robotic commands (30) for directly controlling said robot (41).

9. The method of claim 8, wherein said first set of robotic programming statements (20) are selected from a high-level description file (20).

10. The method of claim 1, wherein said first set of programming statements (20) collectively comprise a robotic presentation (40) to be performed by said robot (41).

11. The method of claim 10, further comprising the step of combining said at least a portion of said third set of robotic commands (30) with at least one of an audio (29) and/or a video multi-media stream (25) for use in said robotic presentation (40).

12. A system for controlling a robot via a high-level programming language, the system comprising:
means for supplying a first set of programming statements (20) defining behaviors to be performed by said robot as a first input to a transformation engine (26);
means for supplying a second set of programming statements (22) organized as a plurality of behavioral templates defining rules for interpreting said behaviors as a second input to said transformation engine (26); and
means for transforming, in the transformation engine (26), said behaviors included in accordance with said defined rules to yield a third set of robotic commands (30) for directly controlling said robot (41).

13. The system of claim 12, wherein said means for transforming further comprises:
means for sequentially selecting said behaviors from said first set of robotic programming statements (20);
means for searching said plurality of behavioral templates (22) for each selected behavior to locate a behavioral template matching said selected behavior, and
means for applying said matching behavioral template to said selected behaviors to yield at least a portion of said third set of robotic commands (30) for directly controlling said robot (41).

14. The system of claim 13, wherein said behavioral templates are searched in a first high-level description file (20).

15. The system of claim 13, wherein said behaviors are selected from a second high-level description file (22).
